(19) United States
(12) Patent Application Publication
(10) Pub. No.: US 2014/0360543 A1
(43) Pub. Date: Dec. 11, 2014

(54) WALKING DEVICE WITH INTEGRATED MISTING FAN

(71) Applicant: Gregory Steiner, Naperville, IL (US)

(72) Inventor: Gregory Steiner, Naperville, IL (US)

(21) Appl. No.: 13/947,739

(22) Filed: Jul. 22, 2013

Related U.S. Application Data
(60) Provisional application No. 61/833,120, filed on Jun. 10, 2013.

(51) Int. Cl. A45B 3/00; B05B 7/24

(52) U.S. Cl. CPC A45B 3/00; B05B 7/2464
USPC 135/66; 239/270

(57) ABSTRACT

A walking device, such as a walking stick, cane, or walker, includes an integral misting fan. The misting fan is coupled to a water reservoir formed into the walking stick. In addition, the misting fan comprises a battery operated an including two or more blades, and a pump assembly coupled to the water reservoir through a tube. The pump is adapted to draw water from the water reservoir through a tube into an atomizer, which is adapted to create a spray of mist through the fan blades. The misting fan can be formed into the handle of the walking device.

### CROSS-REFERENCE TO RELATED APPLICATIONS

The present application claims priority to provisional application number 61/833,120, filed on Jun. 10, 2013 in the name of inventor Gregory A. Steiner. The contents of provisional application No. 61/833,120 are hereby incorporated by reference in their entirety.

### FIELD OF THE DISCLOSURE

The present disclosure generally relates to walking devices. More particularly, the present disclosure relates to walking devices that include an integrated cooling unit. More particularly still, the present disclosure relates to walking sticks, canes, walkers, and other walking assistance devices that include an integrated misting fan to aid in cooling a person.

### DESCRIPTION OF BACKGROUND

Walking sticks are well-known having been used for thousands of years to assist all manners of persons in walking from one locale to another. Generally, a walking stick can be any reasonably straight and sturdy stick that is used as a hand-held walking aid. Folding units, rigid units, wooden units, metal units, and even automatically extending units are known in the art.

Walking canes are a refinement of walking sticks, and generally include a support mechanism to further aid a person in walking. At various times, walking canes have been popular as a fashion accessory. However, they are mostly used to aid injured, elderly, or other mobility impaired persons in walking.

Other walking assistance devices are also known in the art. The most popular of these is the walker, of which an example can be found in U.S. Publication No. 2013/0106070. Unlike a walking stick or cane, which is generally a single legged device (although variations that terminate in multiple feet are known), a walker comprises multiple legs—usually four (although three legged walkers are known as well). The legs of a walker may terminate in wheels or posts, which may be covered with rubber or some other substantially elastic material.

Misting fans are also known in the art. For example, U.S. Pat. No. 5,338,495 (“the '495 patent”), filed in the name of inventors Gregory Steiner and Terry Arnieri, discloses a hand-held misting fan. In particular, the '495 patent discloses a hand-held water misting device adapted to produce a spray through the lower portion of a set of battery operated fan blades. When a user operates a pump it releases a spray of mist directed through or near the blades of a battery operated fan. The mist and the fan produce a cooling effect on the user.

However, there is no known walking assistance device that incorporates a cooling mechanism, such as a water misting fan. Given that many users of walking assistance devices are fragile, and susceptible to heat exhaustion, such a device would fill a long-felt need.

### OBJECTS OF THE DISCLOSED SYSTEM, METHOD, AND APPARATUS

Accordingly, it is an object of this disclosure to provide an improved walking assistance device.

Another object of this disclosure is to provide an improved walking assistance device incorporating a cooling fan.

Another object of this disclosure is to provide an improved walking assistance device incorporating an integrated misting device.

Another object of this disclosure is to provide an improved walking stick incorporating an integrated misting device.

Another object of this disclosure is to provide an improved walking stick including a coupled fan with a pump operated misting atomizer disposed to direct water under the lower blades of the fan.

Other advantages of this disclosure will be clear to a person of ordinary skill in the art. It should be understood, however, that a system or method could practice the disclosure while not achieving all of the enumerated advantages, and that the protected disclosure is defined by the claims.

### SUMMARY OF THE DISCLOSURE

An improved walking stick including an integrated cooling device is disclosed. In particular, a walking stick with a misting fan formed into a handle portion of the walking stick is disclosed. A hub of the fan is formed from a front portion of the handle wherein the hub holds a pair of fan blades. A switch is mounted to the side of the handle, and activates the fan. The hub of the fan is coupled to a substantially circlular guard, which fully encloses a pair of fan blades.

The handle is mounted to a base that is adapted to couple with the top of an elongated shaft, forming the remainder of the walking stick. The interior of the base and the top of the elongated shaft can couple through mated threads. The top of the base holds a hand pump assembly that comprises a depressible pump head that includes a tube that couples with a pump assembly. The tube descends into a water reservoir formed out of the elongated shaft that comprises the main part of the walking stick. When the pump head is depressed, its rising action creates a pressure gradient that draws water from the reservoir into the tube. The pump head further comprises an atomizer, through which the water is drawn. The atomizer creates a spray that is directed through the fan to the front of the handle.

### BRIEF DESCRIPTION OF THE DRAWINGS

Although the characteristic features of this disclosure will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a perspective view of an improved walking stick including an integrated misting fan constructed in accordance with this disclosure;

FIG. 2 is a front view of the upper portion of an improved walking stick including an integrated misting fan constructed in accordance with this disclosure;

FIG. 3 is an exploded front view of the upper portion of an improved walking stick including an integrated misting fan constructed in accordance with this disclosure;

FIG. 4 is a perspective view of a pump assembly for use as a component of an improved walking stick constructed in accordance with this disclosure;

FIG. 5 is a perspective view of a trigger pump assembly for use as a component of an improved walking stick constructed in accordance with this disclosure;

FIG. 6 is a perspective view of a pump sprayer assembly for use as a component of an improved walking stick constructed in accordance with this disclosure;

FIG. 7 is a side view of the top portion of an improved walking stick including an adjustable handle and an integrated misting fan constructed in accordance with this disclosure;

FIG. 8 is an exploded view of a locking and unlocking mechanism for an improved walking stick including an adjustable handle or an adjustable misting fan and constructed in accordance with this disclosure;

FIG. 9 is an operational side view of a locking and unlocking mechanism for use with an improved walking stick and constructed in accordance with this disclosure; and

FIG. 10 is a side view of an improved walking stick including an integrated misting fan that can swivel vertically when an integrated locking and unlocking mechanism is unlocked and constructed in accordance with this disclosure.

### DETAILED DESCRIPTION

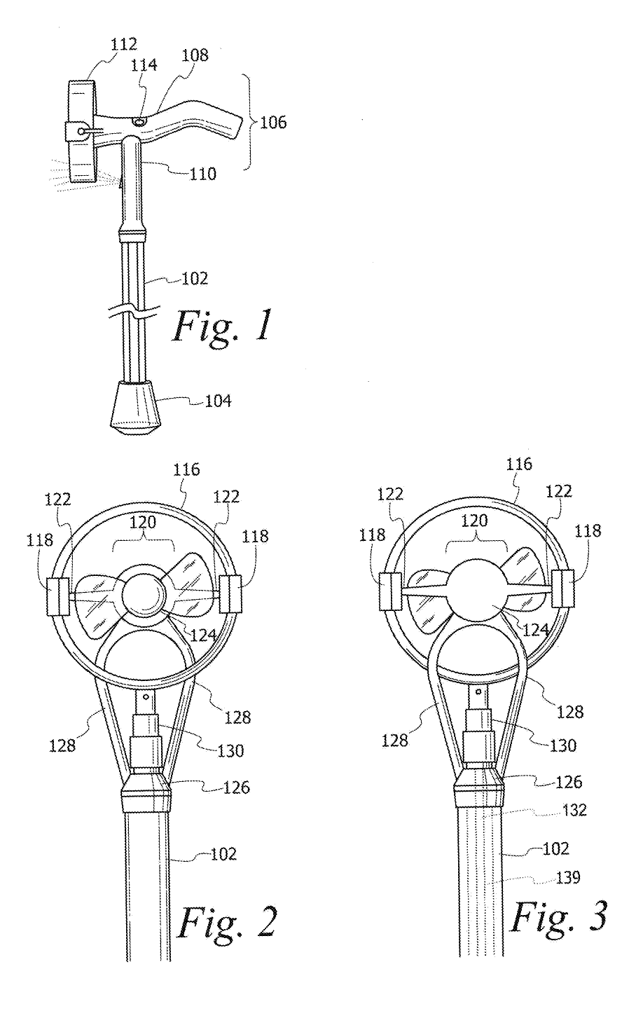

This disclosure addresses walking devices with an integral or attached misting fan for keeping the user cool. Turning to the Figures and to FIG. 1 in particular, an improved walking stick incorporating a misting fan is depicted in perspective. A walking stick 100 comprises an elongated shaft 102 terminating in a ferrule 104. The ferrule 104 provides traction and added support, and can be made of a variety of elastic or semi-elastic materials, such as, for example, rubber. While the pictured walking stick 100 terminates in a single ferrule 104, a variety of cane designs exist, such as three-ferrule canes (tri-canes) and four ferrule canes (quad-canes), which provide additional support for walkers.

Mounted to the top of the elongated shaft 102 is a misting fan and support 106. As depicted the elongated shaft 102 is constructed of aluminum. However, other strong materials could also be used, such as, for example, wood, hard plastic, or steel. The misting fan and support 106 comprises a handle 108 that is constructed to engage a user's hand. As depicted the handle 108 is substantially cylindrical with a lateral arc comprising the rear portion of the handle 108, and is formed of hard plastic, but other materials, such as rubber coated steel, plain steel, or wood could be used, as long as it can be formed to hold the components of the fan as outlined below. The handle could also be of other shapes as are known in the art of walking sticks. The misting fan and support 106 further includes a pump assembly 110 and a battery operated fan 112. The battery operated fan 112 is activated by a switch 114. The battery operated fan 112 comprises a pair of fan blades 120, an electric motor (not shown) and one or more batteries (not shown). The operation of the battery operated fan is as known in the art. As depicted, the fan blades are constructed of a flexible foam material to avoid injuring a user if, for example, her fingers should come into contact with them. Other flexible materials could also be used with the fan design as depicted.

Turning to FIG. 2, the battery operated fan 112 further comprises a substantially circular guard 116. The guard 116 is mounted by a pair of tabs 118. The tabs are directly connected to support arms 122. The support arms 122 are coupled to a hub 124, which is mounted to the front of the handle 108. The handle 108 is mounted to a base 126 by a pair of formed support arms 128. The base 126 supports a pump assembly 130. As discussed further herein, the base 126 is mounted to the end of the elongated shaft 102 by a threaded connection (discussed further herein).

As depicted, the battery operated fan 112 has an open design, in that the fan blades are accessible. Closed designs wherein a guard fully encloses the fan blades can also be used. In such a design, the fan blades could be constructed of harder materials, such as hard plastic or steel, as there is no risk of user injury given that the blades are inaccessible.

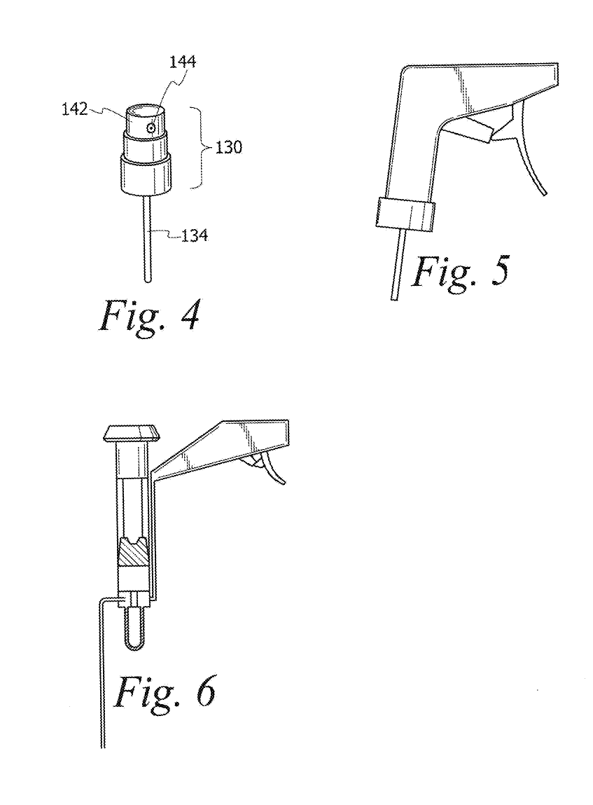

FIG. 3 is an exploded view of the improved walking stick 100, showing the interior of the walking stick 100. In particular, it displays the water reservoir 134, which is formed out of a well in the interior of the walking stick 100. The water reservoir 134 is coupled to the pump assembly 130 by a tube 132.

As depicted the fan is formed from the handle of the walking stick. However, the fan could also be attached the walking stick by a clip or other means. If the fan and pump assembly is attached to the walking stick, it will also require a water reservoir, which could be, for example, a substantially cylindrical plastic container coupled to the pump assembly through a tube.

Turning to FIG. 4, the pump assembly 130 comprises a depressible pump head 142 that is coupled to a tube 134. When the depressible pump head 142 is operated, it is adapted to create a pressure gradient that draws fluid from the water reservoir 134 and directs it through an atomizer 144. The atomizer 144 is adapted to create a spray of mist.

As implemented, the pump assembly 130 is disposed under the circular guard 116, which allows the fan 112, when it is operated to disperse a spray to the front of the walking stick 100. It should be noted that the pump assembly 130 could also be disposed to spray, for example, through the hub 124, above the guard 116, or directly through the guard 116 and fan blades 120, The positioning of the pump assembly 130 is not a limitation of this invention as long as it is disposed so that the fan blades 120, when operating, serve to disburse the spray created by atomizer 144. Further, while a pair of fan blades are shown, three blades, four blades, or another number of fan blades could be used as well.

It should be noted that other types of pumps could be used as well. For example, a trigger type nozzle utilizing a reciprocating piston pump, such as that depicted in FIG. 5 could be used. In addition, a pump type sprayer, wherein a user develops pressure in a system by pre-pumping a lever, and then utilizes a trigger nozzle to actually spray mist, as disclosed in FIG. 6 could be used as well. Other types of pumps, such as a motor driven pump could also be used.

While a walking stick comprising a single section is depicted, other walking stick designs could be used as well. For example, a folding walking stick, comprising three or four sections could also be used, wherein the water reservoir would be formed into a first section, and the misting fan and support assembly coupled with the first section. In addition, while the disclosure primarily discusses a misting integrated with a walking stick, a misting fan could also be coupled with other walking assistance devices, such as various types of walkers. In addition, the battery operated fan 112 can be a swiveling or rotating fan, as opposed to a fixed fan. When the battery operated fan 112 is a fixed fan, the user must manually point the fan in the desired direction by manipulating the walking stick 100. However, if the battery operated fan 112 is able to swivel, the user can plant the walking stick in a location, swivel the fan toward the user, and lock the fan in place. Furthermore, if the battery operated fan 112 is adapted to rotate, it is better adapted to serve a dual purpose in that it can act as a walking aid for the user, as well as act as a room fan to cool multiple people. It should be noted that to fully take advantage of a swiveling or rotating fan, the walking stick 100 could be self-supporting. Accordingly, a tri-cane or quad-cane could provide greater efficacy in such a configuration.

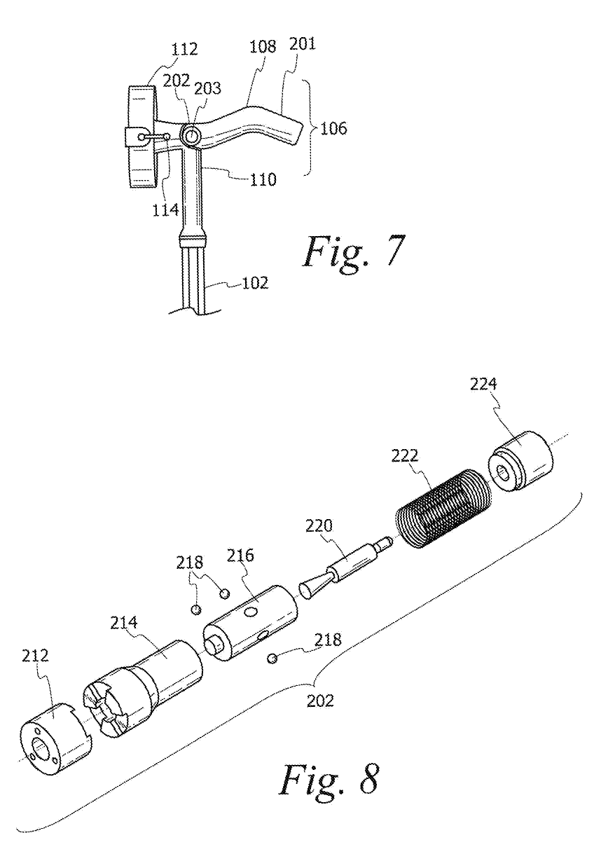

Turning to FIG. 7, a perspective view of an improved walking stick integrating an adjustable handle 108 with an integrated misting fan. The rear portion 201 of adjustable handle 108 can swivel vertically when a button 203 on the side of the handle 108 is depressed. When the button 203 is released, a locking and unlocking mechanism 202 locks the handle 108 in place. The locking and unlocking mechanism 202 provides a substantial amount of adjustment in the placement of the rear portion of the handle 201.

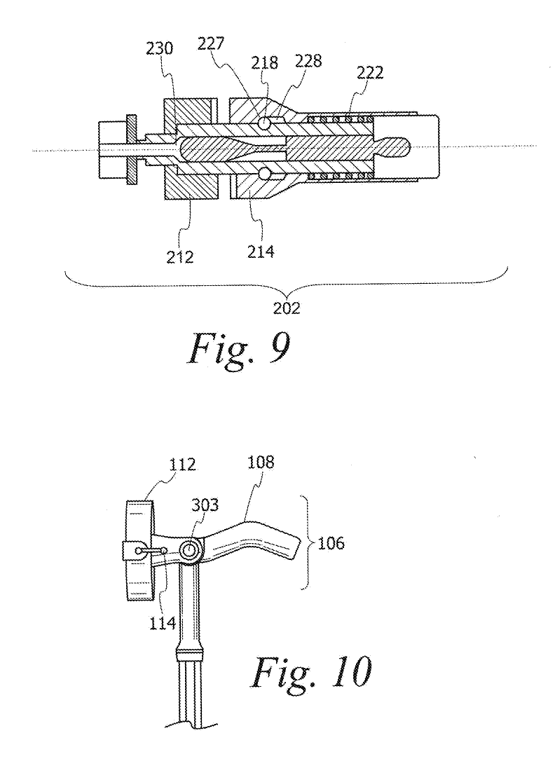

Turning to FIGS. 8 and 9, the workings of the locking and unlocking mechanism 202 is detailed. A push-button 224 is located at a distal end of the rotation locking mechanism 202. When the push-button 224 is depressed, two interlocking portions 212 and 214 are moved into an unlocked position. When in the unlocked position, the interlocked portions 212 and 214 allow free rotation. When the push-button 224 is released, sprint 222 acts on the two interlocking portions 212 and 214, which are moved into a locked position. When in the locked position the interlocking portions 212 and 214 prevent any rotation.

When depressed, the push-button 224 pushes upon a plunger, that travels through an elongated hollow tube 216 towards interlocking portion 212. The movement of the plunger 220 activates a lock release 226. In the illustrated embodiment, the lock release 226 is implemented as a ball bearing 218, which is moved from an internal recess 228 into a bore 230 of the elongated hollow tube 216. When the push-button 224 is released the spring 222 pushes the plunger 220 through elongated hollow tube 216.

FIG. 10 depicts another embodiment of the disclosed improved walking stick. In this embodiment, the misting fan 112 is adapted to swivel vertically while the user presses a pushbutton 303. The other elements of the disclosed walking stick are similar to the previously disclosed embodiments, including a weight bearing handle 108. In this embodiment, the pushbutton 303 activates a locking and unlocking mechanism, such as, for example, that disclosed in FIGS. 8 and 9.

The foregoing description of the disclosure has been presented for purposes of illustration and description, and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It is intended that the scope of the disclosure not be limited by the specification, but be defined by the claims set forth below. In addition, although narrow claims may be presented below, it should be recognized that the scope of this invention is much broader than presented by the claim(s), It is intended that broader claims will be submitted in one or more applications that claim the benefit of priority from this application. Insofar as the description above and the accompanying drawings disclose additional subject matter that is not within the scope of the claim or claims below, the additional inventions are not dedicated to the public and the right to file one or more applications to claim such additional inventions is reserved.

What is claimed is:

1. A battery operated misting fan adaptively coupled to a walking device, the battery operated misting fan comprising:
i) a water reservoir;
ii) an atomizer coupled to the water reservoir through a tube;
iii) a pump coupled to the atomizer and the water reservoir, the pump adapted to draw water from the water reservoir through the tube and direct it through the atomizer creating a spray of mist;
iv) a battery-operated fan coupled to the walking device, the blades of the battery-operated fan disposed to direct the spray of mist; and
v) a switch coupled to the battery-operated fan, the switch adapted to activate the battery-operated fan.

2. The battery operated misting fan of claim 1 wherein the walking device is a walking stick.

3. The battery operated misting fan of claim 2 wherein the walking stick is a cane.

4. The battery operated misting fan of claim 1 wherein the walking device is a walker.

5. A walking stick including an elongated shaft, the walking stick comprising:
i) a water reservoir disposed within the elongated shaft;
ii) an atomizer coupled to the water reservoir through a tube;
iii) a pump coupled to the atomizer and the water reservoir, the pump adapted to draw water from the water reservoir through the tube and direct it through the atomizer creating a spray of mist;
iv) a battery-operated fan coupled to the walking stick, the blades of the battery-operated fan disposed to direct the spray of mist; and
v) a switch coupled to the battery-operated fan, the switch adapted to activate the battery-operated fan.

6. The walking stick of claim 5 further comprising a hand grip, the hand grip disposed orthogonal to the elongated shaft and mounted on one end of the orthogonal shaft, wherein the fan is mounted onto an end of the of the hand grip.

7. The walking stick of claim 6 wherein the battery-operated fan comprises a substantially circular guard as well as a plurality of fan blades disposed to rotate within the circumference of the substantially circular guard.

8. The walking stick of claim 7 wherein the atomizer is disposed at least partially beneath the outer circumference of the substantially circular guard.

9. The walking stick of claim 7 wherein the atomizer is integrated into the pump and wherein the pump comprises a set of integral threads on the interior of the pump and wherein one end of the elongated shaft comprises a set of threads, and wherein the pump is coupled to the elongated shaft by the threads.

10. A walking stick including an elongated shaft, the walking stick comprising:
i) a hand grip disposed on a first end of the walking stick, the handle adapted to interface with a hand of a user;
ii) a ferrule disposed on a second end of the walking stick, the ferrule adapted to provide traction on a variety of a surfaces;
iii) a battery operated fan connected to the walking stick, the battery operated fan comprising a plurality of blades connected to a center hub; and
iv) a switch coupled to the battery-operated fan, the switch adapted to activate the battery-operated fan.

11. The walking stick of claim 10 wherein the hand grip is disposed orthogonal to the elongated shaft and wherein the hand grip is mounted to the elongated shaft by a set of threads disposed on a bottom end of the hand grip.

12. The walking stick of claim 11 wherein the battery-operated fan is disposed within the hand-grip.

13. The walking stick of claim 12 wherein the battery-operated fan comprises a substantially circular guard as well as a plurality of fan blades disposed to rotate within the circumference of the substantially circular guard.
